(19) United States
(12) Patent Application Publication
(10) Pub. No.: US 2026/0027463 A1
(43) Pub. Date: Jan. 29, 2026

(54) SWIPE-BASED VISUAL TRIVIA GAME SYSTEM

(71) Applicant: Vincent Dijkema, Harderwijk (NL)

(72) Inventor: Vincent Dijkema, Harderwijk (NL)

(21) Appl. No.: 19/272,237

(22) Filed: Jul. 17, 2025

Related U.S. Application Data
(60) Provisional application No. 63/676,384, filed on Jul. 28, 2024.

(51) Int. Cl. A63F 13/537; A63F 9/18; A63F 13/67

(52) U.S. Cl. CPC A63F 13/537; A63F 9/183; A63F 13/67

(57) ABSTRACT

A computer-implemented method for operating a trivia game is disclosed. The method includes presenting, via a display interface, a plurality of trivia questions, each comprising a combination of a visual stimulus and an associated textual prompt. A swipe-based interaction mechanism is used to detect user input indicating a response as to whether the presented combination is true or false. The method further includes awarding one or more virtual keys to a user for responding to questions, and managing the use of virtual keys to unlock virtual treasure chests. Lives are deducted for incorrect responses and may be restored over time or through user interaction with advertisements. The method also involves tracking user performance based on correct and incorrect responses and modifying the difficulty of subsequently presented questions based on the tracked performance. The method enhances user engagement through dynamic difficulty adjustment and incentivized in-game progression.

### CROSS-REFERENCE TO RELATED APPLICATIONS

This application claims the benefit of U.S. Provisional Patent Application No. 63/676,384 filed on Jul. 28, 2024, the entire disclosure of which is incorporated herein by reference.

### FIELD OF THE INVENTION

The present invention relates to interactive mobile gaming, specifically trivia games combining visual and textual elements encompassing systems and methods for presenting image-text pair questions, utilizing swipe-based user interactions, and implementing resource management mechanics.

### BACKGROUND OF THE INVENTION

In recent years, the mobile gaming industry has experienced exponential growth, with trivia games maintaining a significant share of the market. However, despite their popularity, many trivia games have become stagnant, relying on outdated formats that fail to fully engage modern users accustomed to dynamic, visually-rich experiences. Traditional text-based trivia games often struggle to capture and maintain player interest, especially among younger demographics who are increasingly drawn to more interactive and visually stimulating content.

The current state of the art in trivia games typically involves presenting players with textbased questions and multiple-choice answers. While this format has been successful in the past, it fails to take advantage of the advanced capabilities of modern mobile devices, such as highresolution displays and touch-based interfaces. Moreover, these games often lack the immediacy and intuitive interaction that today's users expect, potentially leading to decreased engagement and retention rates.

Another significant deficiency in many existing trivia games is their inability to effectively combine educational content with entertaining gameplay mechanics. Many games either focus too heavily on education at the expense of enjoyment or prioritize entertainment without providing substantial learning value. This imbalance can result in games that fail to satisfy users seeking both fun and intellectual stimulation.

Furthermore, current trivia games often struggle with difficulty adjustment, presenting either overly challenging or too easy questions that fail to adapt to individual player skills and knowledge levels. This lack of personalization can lead to frustration or boredom, causing players to lose interest over time.

The mobile gaming landscape presents numerous opportunities for innovation in the trivia genre. The widespread adoption of smartphones with advanced touch interfaces and high quality displays opens up possibilities for more engaging and interactive gameplay mechanics. Additionally, the increasing demand for educational entertainment (edutainment) creates a market for games that can effectively blend learning with fun, catering to users who seek to expand their knowledge while being entertained.

In light of these challenges and opportunities, the objective of this invention is to create a novel trivia game system that addresses the shortcomings of traditional formats while capitalizing on the capabilities of modern mobile devices.

### BRIEF SUMMARY OF THE INVENTION

It is an object of the present invention to provide a trivia game system comprising a display interface configured to present trivia questions generated by combining a visual stimulus and an associated textual prompt.

It is another object of the present invention to provide a trivia game system including a swipe-based interaction mechanism configured to detect directional user input indicating whether the presented trivia combination is true or false.

It is yet another object of the present invention to provide a key management module configured to award keys for correct responses and manage the unlocking of virtual treasure chests based on accumulated keys.

It is another object of the present invention to provide a life management module configured to deduct game lives for incorrect responses or answers, and restore lives either over time or in response to user interaction with advertisements.

It is a further object of the present invention to provide a scoring module configured to track user performance based on correctness of responses, and a difficulty adjustment module configured to modify the difficulty of subsequent questions accordingly.

It is another object of the present invention to provide a trivia game system supporting video advertisements that enable users to skip questions without penalty and receive rewards, including keys, in exchange for ad engagement.

It is another object of the present invention to provide a multiplayer module configured to facilitate competitive or cooperative trivia gameplay between multiple users, track multiplayer performance, and award ranking points based on game outcomes.

It is yet another object of the present invention to provide a wagering option that enables users to set custom stakes using in-game currency during multiplayer games.

It is another object of the present invention to provide a subscription option that, when activated, disables banner advertisements while preserving the functionality of video advertisements for core gameplay operations.

It is a further object of the present invention to provide a question generation module configured to generate trivia questions by dynamically selecting a visual stimulus and an associated textual prompt from respective databases.

It is yet another object of the present invention to improve user engagement by adjusting the complexity of trivia questions through the selection of more challenging visual and textual combinations based on user performance history.

According to an embodiment of the present invention, a trivia game system is disclosed, comprising a question generation module configured to generate a plurality of trivia questions, each including at least one visual stimulus and a textual prompt, for presentation on a display interface. A swipe-based interaction mechanism detects user input indicating whether the combination of the visual stimulus and textual prompt is true or false. A key management module awards virtual keys for responding to questions and manages their use to open virtual treasure chests. The system further includes a game life management module configured to deduct game lives for incorrect responses, restore lives over time, and restore lives through user interaction with advertisements. A scoring module tracks user performance based on correct and incorrect responses. A difficulty adjustment module modifies the difficulty of presented questions based on tracked performance. The system enhances user engagement by combining visual learning, real-time interaction, performance-based rewards, and adaptive difficulty progression.

According to an embodiment of the present invention, a computer-implemented method for operating a trivia game is disclosed. The method includes presenting, via a display interface, a plurality of trivia questions, each comprising a combination of a visual stimulus and an associated textual prompt. A swipe-based interaction mechanism is used to detect user input indicating a response as to whether the presented combination is true or false. The method further includes awarding one or more virtual keys to a user for responding to questions, and managing the use of virtual keys to unlock virtual treasure chests. Lives are deducted for incorrect responses and may be restored over time or through user interaction with advertisements. The method also involves tracking user performance based on correct and incorrect responses and modifying the difficulty of subsequently presented questions based on the tracked performance. The method enhances user engagement through dynamic difficulty adjustment and incentivized in-game progression.

### BRIEF DESCRIPTION OF THE DRAWINGS

The novel features believed to define the illustrative embodiments are detailed in the appended claims. To fully comprehend these embodiments, along with their preferred usage, objectives, and detailed descriptions, one should refer to the comprehensive description of the one or more examples of these embodiments, as provided in this disclosure. This understanding is further enhanced when considered alongside the accompanying drawings, wherein:

FIG. 1 is a block diagram illustrating a trivia game system, according to some embodiments of the present disclosure.

FIG. 2 is a block diagram further illustrating the trivia game system from FIG. 1, according to some embodiments of the present disclosure.

FIG. 3 is a block diagram further illustrating the trivia game system from FIG. 1, according to some embodiments of the present disclosure.

FIG. 4 is a block diagram further illustrating the trivia game system from FIG. 1, according to some embodiments of the present disclosure.

FIG. 5A is a flowchart illustrating a computer-implemented method for operating a trivia game, according to some embodiments of the present disclosure.

FIG. 5B is a flowchart extending from FIG. 5A and further illustrating the computer implemented method for operating a trivia game, according to some embodiments of the present disclosure.

FIG. 6 is a flowchart further illustrating the computer-implemented method for operating a trivia game from FIG. 5A, according to some embodiments of the present disclosure.

FIG. 7 is a flowchart further illustrating the computer-implemented method for operating a trivia game from FIG. 5A, according to some embodiments of the present disclosure.

FIG. 8 is a flowchart further illustrating the computer-implemented method for operating a trivia game from FIG. 5A, according to some embodiments of the present disclosure.

FIG. 9 is a flowchart further illustrating the computer-implemented method for operating a trivia game from FIG. 5A, according to some embodiments of the present disclosure.

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

The detailed description of the preferred embodiments of this invention for an interactive trivia game system is presented here, with references to the accompanying drawings. The specific terms and words used in both the description and the claims of this invention should not be confined to their ordinary or dictionary definitions. Instead, their interpretation should align with the meanings and concepts relevant to the trivia game invention, reflecting the inventor(s)′ ability to define terms uniquely to best convey the invention.

It should be noted that the embodiments of the trivia game invention illustrated and discussed in this document represent preferred examples, and do not intend to restrict the technical essence or boundaries of the invention. Therefore, it is important to acknowledge that various alterations and adaptations can be made to the interactive trivia game system, which are still within its spirit and scope. For example, additional visual stimuli types, advanced gesture recognition, integration with social media platforms, and incorporation of augmented reality features may be implemented over time to further enhance the gaming experience, while retaining alignment with the core inventive concept of a visually-rich, swipe-based trivia game with adaptive difficulty and resource management mechanics.

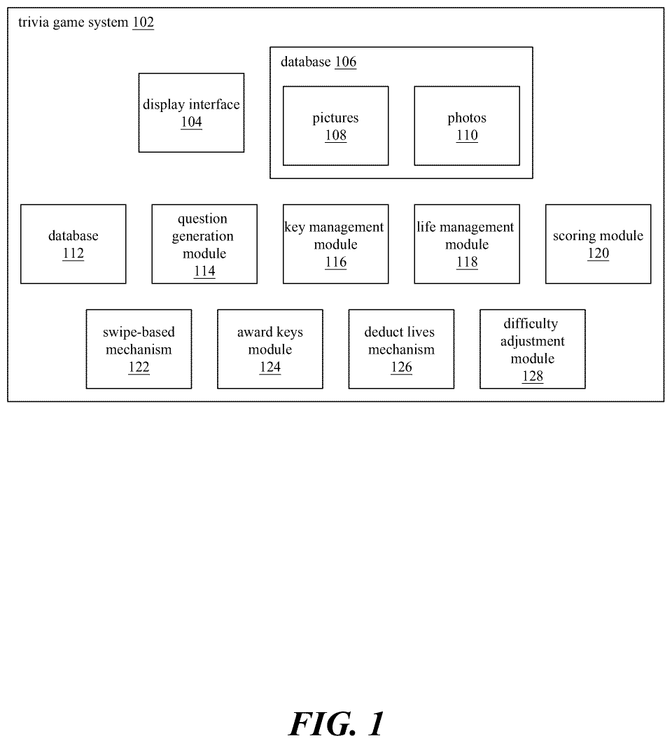

FIG. 1 is a block diagram depicting a trivia game system 102, according to various embodiments of the present disclosure. In some embodiments, the trivia game system 102 includes a display interface 104 configured to present trivia questions to the user in an interactive format. The system further includes a first database 106 storing a plurality of visual stimuli, wherein the visual stimuli may include pictures 108 and photos 110, which may be tagged by category, difficulty, or theme-based. The system further include a second database 112 storing a plurality of textual prompts, each textual prompt associated with at least one of the visual stimuli for contextual pairing for trivia question creation.

In some embodiments, the display interface 104 includes a graphical user interface (GUI) configured to visually present a plurality of trivia questions, visual stimuli, textual prompts, scores, lives, keys, advertisements, and other game-related elements. The GUI is configured to support intuitive interaction through visual icons, swipable content panels, progress indicators, and touch-responsive elements. Further, the trivia game system 102 may be implemented on a variety of computing platforms or devices, including but not limited to: a smartphone, a tablet computer, a smart television, a desktop computer, a laptop computer, a gaming console, a virtual reality (VR) headset, an augmented reality (AR) headset, a smart display, or a wearable device such as a smartwatch. In some embodiments, the system 102 may be implemented as a native application, a web-based application, or a cloud-streamed interactive gaming session in the aforementioned devices.

In an exemplary embodiment, the trivia game system 102 further comprises a question generation module 114 configured to generate trivia questions by combining at least one visual stimulus with a textual prompt, which is intended to be presented to the user. The pairing may be dynamically selected by the question generation module 114 based on one or more parameters.

In another exemplary embodiment, the system 102 includes a swipe-based interaction mechanism 122 configured to detect user input via at least one directional gesture. The directional gesture includes swiping the display interface 104 to indicate whether the statement formed by the visual stimulus and textual prompt is true or false. In an embodiment, the trivia game system 102 further includes a key management module 116 configured to award one or more virtual keys 124 to the user for correctly responding (answering) trivia questions. The key management module 116 may further manage the use of the keys 124 to unlock one or more virtual treasure chests, which may contain in-game rewards such as bonus content, power-ups, or in-game currency.

The trivia game system 102 also include a game life management module 118 configured to manage game lives. In one embodiment, game life management module 118 represent the user's allowed number of incorrect attempts during gameplay. In one other embodiment, the game life management module 118 may be configured to deduct games lives 126 (attempts) from the user's total count when an incorrect response (answer) is submitted by the user. When the user's available game lives are depleted, gameplay may be temporarily suspended or limited. The life management module 118 may also be configured to automatically restore game lives over time based on a predefined time-recovery algorithm. Additionally, game lives may be restored immediately in response to specific user interactions, such as engaging with in-game advertisements, completing incentivized video viewing, or participating in promotional activities.

In an embodiment a scoring module 120 is configured to track user performance based on correct and incorrect responses, timing, and question difficulty. Performance metrics may be stored and used to inform player progression, unlock achievements, or adjust in-game rewards. The trivia game system 102 may also include a difficulty adjustment module 128 configured to modify the difficulty level of the trivia questions presented to the user. In various aspects, the module may utilize performance data such as the user's accuracy rate, response time, and category-based success to dynamically adjust question complexity, such as by selecting more nuanced prompts or less familiar images in response to improved performance.

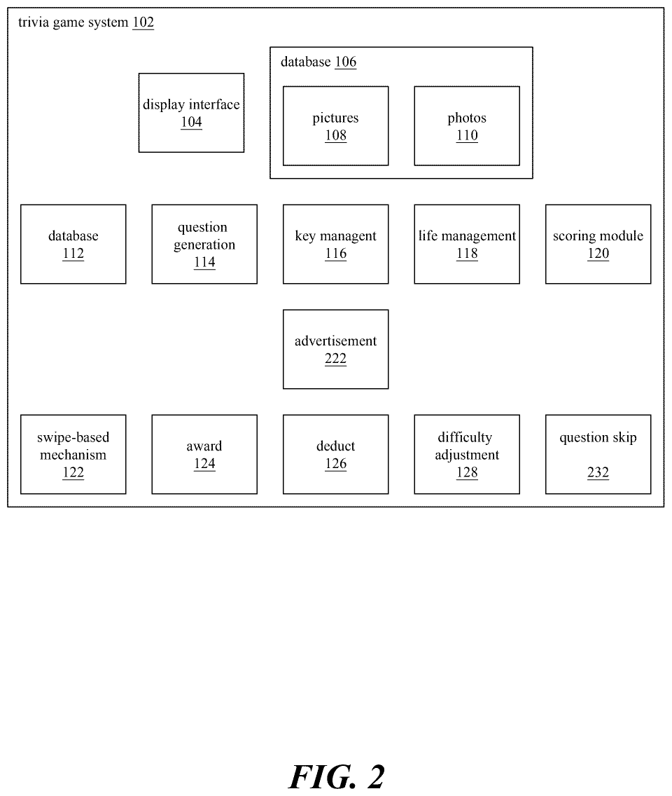

FIG. 2 is a block diagram depicting the trivia game system 102 from FIG. 1, according to another embodiment of the present disclosure. In some embodiments, the trivia game system 102 may include an advertisement module 222 configured to present video advertisements to the user during gameplay. The advertisement module 222 may be integrated into the user interface and triggered under certain gameplay conditions or upon specific user actions. In one aspect, the trivia game system 102 includes a question skip option 232 that allows users to skip a trivia question by choosing to watch a video advertisement presented via the advertisement module 222. Upon completion of the advertisement, the trivia question presented at the time of ad initiation may be marked as completed, and then the user is allowed to progress in the game without deducting game lives for not answering the question.

In one aspect, the skipped question may not affect the user's score or performance metrics negatively. In some embodiments, the key management module 116, as described with reference to FIG. 1, may be configured to award keys for the skipped question, even though the user did not submit a response. The integration of the advertisement module 222, question skip option 232, and key management module 116 enables an alternative reward pathway linked to user interaction with sponsored content.

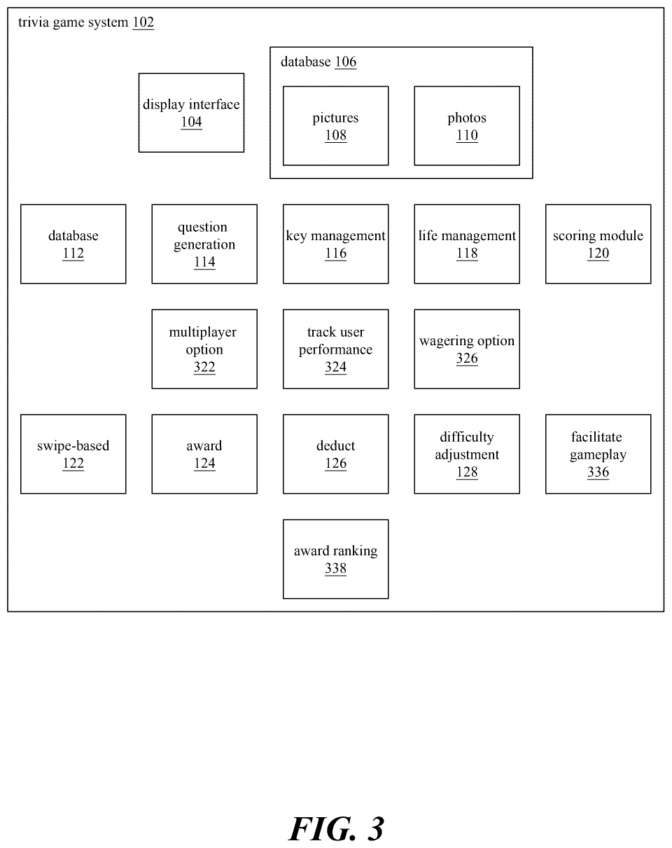

Referring to FIG. 3, a block diagram of the trivia game system 102 is depicted according to another embodiment of the present disclosure. In some embodiments, the trivia game system 102 includes a multiplayer module 322 configured to enable social and competitive gameplay experiences. In one aspect, the multiplayer module 322 may be configured to facilitate gameplay 336 between multiple users, thereby allowing users to participate in real-time or asynchronous trivia challenges, cooperative rounds, or head-to-head match formats.

The multiplayer module 322 may further be configured to track user performance 324 in multiplayer games, including metrics such as correct answer rates, time to respond, win-loss history, and consistency in multiplayer rounds. These performance data points may be maintained separately from single-player performance tracked by the scoring module 120 described with reference to FIG. 1. In some embodiments, the multiplayer module 322 may also be configured to award ranking points 338 based on multiplayer game outcomes, thereby supporting leaderboard progression, skill tier classification, or tournament seeding within the trivia game system 102. Rankings may be updated dynamically and displayed within the user interface to reflect real-time performance standings.

Additionally, the trivia game system 102 may include a wagering option 326 as part of the multiplayer module 322, which allows users to set custom wagers using in-game currency when participating in multiplayer games. The wagering option 326 may be configurable by the users and may be subject to predefined limits or constraints to maintain fair gameplay. The outcome of the multiplayer match may determine the distribution of wagered in-game currency.

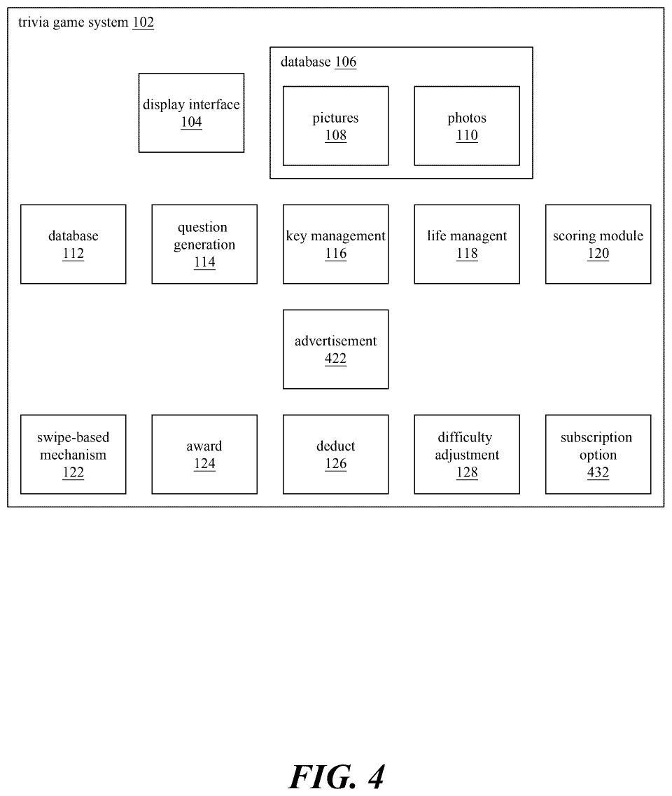

Referring to FIG. 4, a block diagram of the trivia game system 102 is depicted according to another embodiment of the present disclosure. In some embodiments, the trivia game system 102 may include an advertisement integration module 422 configured to display banner advertisements within the game interface (display interface 104). The advertisement integration module 422 may be responsible for embedding non-intrusive ad content into designated areas of the user interface during gameplay, menus, or idle states, thereby allowing for continuous ad-based monetization without disrupting the core trivia experience.

The trivia game system 102 may also include a subscription option 432, which provides users with the ability to modify their gameplay experience through a paid or premium plan. When the subscription option 432 is activated, the system 102 may disable the display of banner advertisements controlled by the advertisement integration module 422, resulting in an ad-free interface. In an exemplary embodiment, the subscription option 432 is configured to maintain the functionality of video advertisements associated with other modules, such as restoring game lives through the life management module 118 or skipping questions via the question skip option 232 described in reference to FIG. 2.

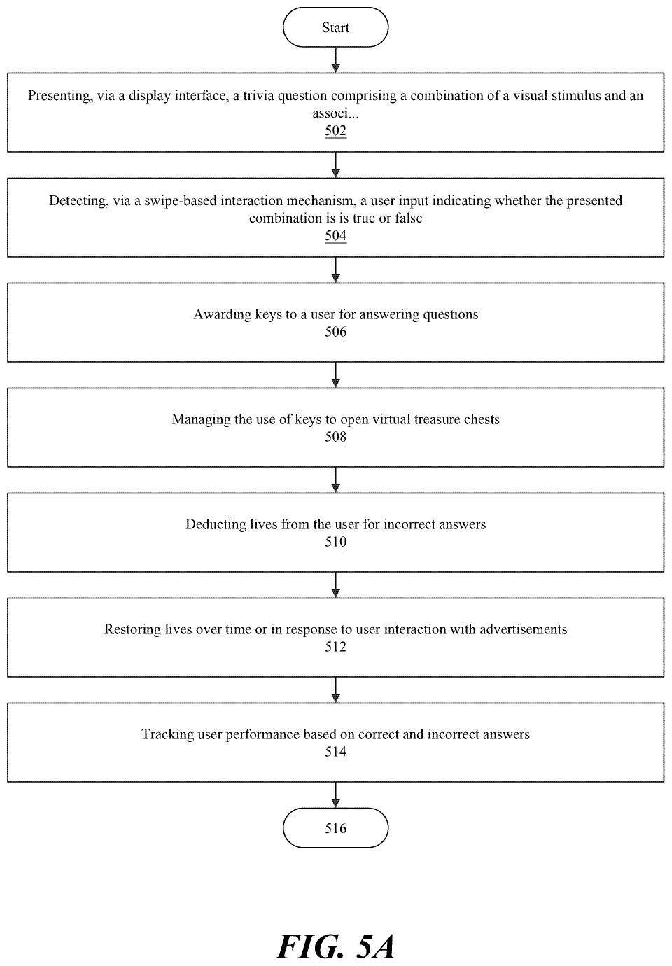

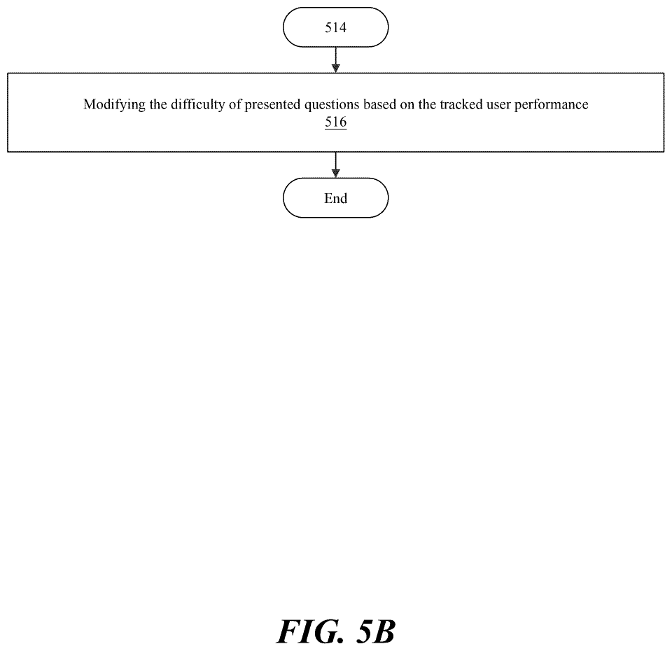

Referring to FIGS. 5A to 5B flowcharts illustrating a computer-implemented method for operating a trivia game is disclosed according to another embodiment of the present disclosure. The method is implemented using the system 102 disclosed in preceding embodiments. In some embodiments, at 502, the computer-implemented method include presenting, via a display interface, a trivia question comprising a combination of at least one visual stimulus and an associated textual prompt, both of which may be retrieved from respective databases-visual stimuli such as pictures or photos from database 106 and textual prompts from the database 112, as shown in FIG. 1. The visual and textual elements are rendered together to form a trivia question for evaluation by the user.

At 504, the method includes detecting, via a swipe-based interaction mechanism, a user input indicating whether the presented combination may be true or false. The swipe-based interaction mechanism 122 interprets directional swipes (e.g., right for true, left for false) as user responses. At 506, the method further include awarding keys to a user for responding (answering) questions correctly, wherein the awarding process is handled by the key management module 116, specifically via the award keys 124 functionality.

In some embodiments, at 508, the computer-implemented method also include managing the use of one or more keys to open virtual treasure chests, wherein the virtual reward logic is controlled by the key management module 116. At 510, the method further includes deducting lives from the user's game for incorrect answers. At 512, the method includes restoring lives over time or in response to user interaction with advertisements, which may integrate passive life recovery along with ad-based recovery through modules such as the advertisement module 222 described in FIG. 2. At 514, the method includes tracking user performance based on correct and incorrect answers, wherein tracking is performed by the scoring module 120, which logs user accuracy, response speed, and possibly category-specific performance.

At 516, the method further includes modifying the difficulty of presented questions based on the tracked user performance, using the difficulty adjustment module 128 to dynamically adjust the complexity of future questions by analyzing the performance data collected over time.

In some embodiments, presenting the trivia question comprises simultaneously displaying the visual stimulus and the associated textual prompt on the display interface 104, thereby ensuring an integrated presentation that enhances comprehension. In some embodiments, managing the use of keys comprises awarding virtual treasure chests only when all questions in a predefined series may be answered correctly, thereby incentivizing complete accuracy in structured rounds of gameplay.

In some embodiments, the visual stimulus may be selected from a database of visual stimuli including pictures or photos, and the textual prompt may be selected from a database of textual prompts, each textual prompt being associated with at least one of the visual stimuli, as maintained in the second database 112. In some embodiments, modifying the difficulty of presented questions comprises selecting visual stimuli and textual prompts that create more challenging combinations based on the user's improved performance.

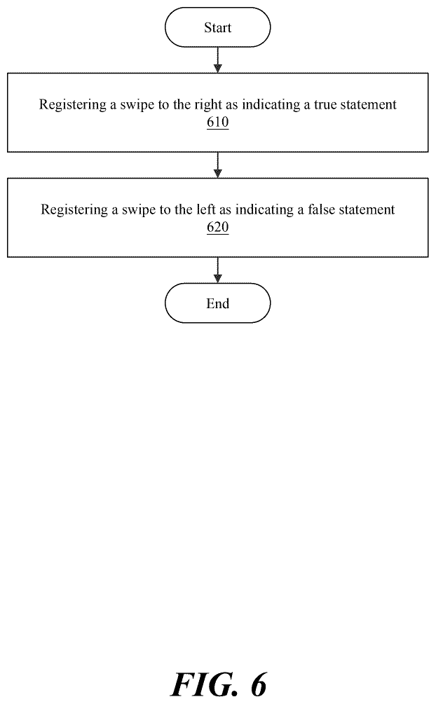

FIG. 6 is a flowchart illustrating a computer-implemented method for operating a trivia game, according to an embodiment of the present disclosure. In particular, FIG. 6 depicts the input detection process corresponding to step 504 of FIG. 5A, which involves detecting, via a swipe-based interaction mechanism, a user input indicating whether the presented combination of a visual stimulus and an associated textual prompt may be true or false.

At 610, the method includes the step of registering a swipe to the right as indicating a true statement, wherein the swipe-based interaction mechanism 122 interprets the direction of the user's gesture on the display interface to signal a “true” response. At 620, the method includes the step of registering a swipe to the left as indicating a false statement, thus allowing the system to capture a “false” response based solely on directional input.

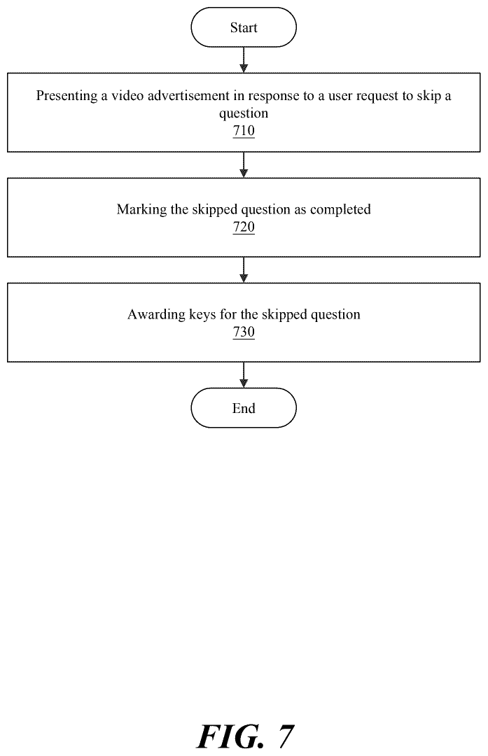

Referring to FIG. 7 a flowchart illustrating a computer-implemented method for operating a trivia game is disclosed according to another embodiment of the present disclosure. In particular, FIG. 7 depicts the optional ad-based question skip mechanism, which complements the core trivia flow outlined in FIG. 5A. In some embodiments, at 710, the method involves the step of presenting a video advertisement in response to a user request to skip a question. The interaction as in 710 may be initiated by the user through the game interface, thereby triggering the advertisement module 222 (as shown in FIG. 2) to display an incentivized video ad. The ad must be viewed by the user in full or as per predefined rules before the skip takes effect.

At 720, following the completion of viewing the advertisement, the method involves the step of marking the skipped question as completed, such that the question is recorded as addressed and the user is allowed to proceed without submitting a true or false input. In one embodiment, optionally, the system 102 may log the skipped question to prevent it from affecting performance scoring or being repeated immediately.

At 730, the method further involves awarding one or more keys for the skipped question, utilizing the logic of the key management module 116 described in FIG. 1. In one embodiment, despite the question being skipped, the system 102 may still grant keys as a form of reward for engaging with the video advertisement. The incentivization supports ad monetization while preserving gameplay flow and progression within the trivia game system.

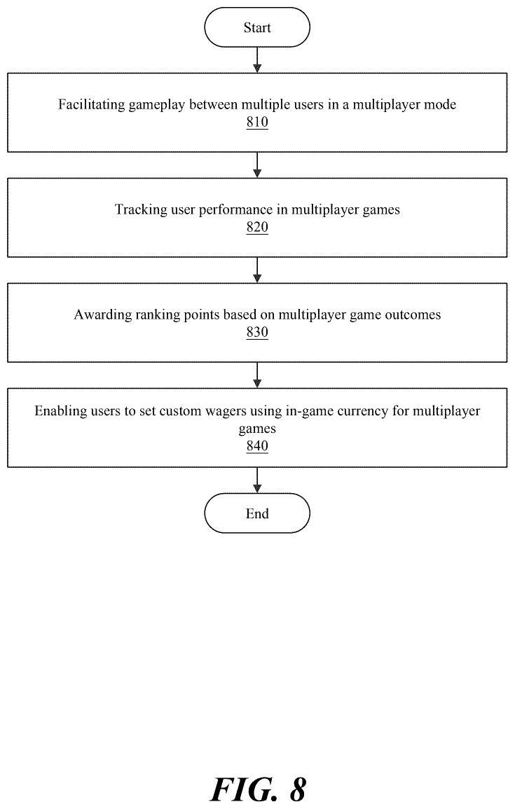

Referring to FIG. 8, a flowchart illustrating a computer-implemented method of operating a trivia game is disclosed according to an embodiment of the present disclosure. FIG. 8 particularly depicts steps involved in multiplayer gameplay mode, which complements the core question-answering mechanics outlined in FIG. 5A by enabling social and competitive user interactions within the trivia game system.

In one embodiment, at 810, the method involves the step facilitating gameplay between multiple users in a multiplayer mode. The step 810 may involve real-time or asynchronous match setups, challenge invitations, or matchmaking features provided by the multiplayer module 322 as shown in FIG. 3. The multiplayer functionality enables users to compete in trivia rounds either cooperatively or competitively. At 820, the method further involves the step of tracking user performance in multiplayer games, such as measuring correct answer rates, time to answer, round wins, and category-based proficiency. The multiplayer-specific performance metrics may be tracked using track user performance 324 functionality associated with the multiplayer module.

At 830, the method involves the step of awarding ranking points based on multiplayer game outcomes, where the award ranking 338 function assigns points to users based on win/loss status, relative performance, or other outcome-based factors. These points may contribute to overall leaderboards, seasonal rankings, or player tiers within the game ecosystem. At 840, the method further involves the step of enabling users to set custom wagers using in-game currency for multiplayer games. The wagering option 326 allows users to specify a stake prior to the start of a multiplayer round.

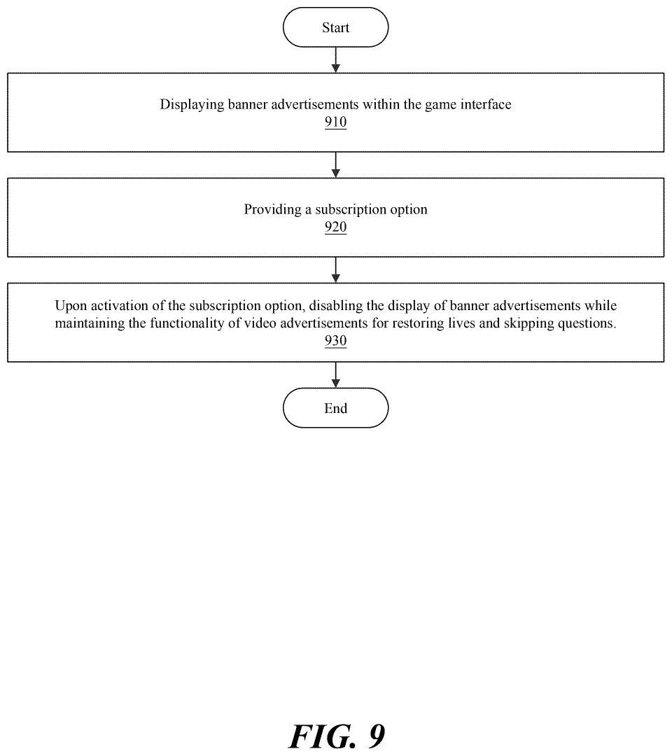

Referring to FIG. 9 a flowchart illustrating a computer-implemented method for operating a trivia game is disclosed according to an embodiment of the present disclosure. FIG. 9 specifically illustrates an embodiment related to advertisement management and subscription-based user experience customization within the trivia game system 102. In an embodiment, at 910, the method involves the step of displaying banner advertisements within the game interface, wherein the banner ads are presented by the advertisement integration module 422 (as shown in FIG. 4). These banner advertisements may appear persistently or contextually during gameplay, menus, or idle screens, thus serving as a continuous monetization mechanism.

At 920, the method involves the step of providing a subscription option, such as a paid or premium upgrade tier, which is made available to the user within the game interface. The subscription option 432 provides users an alternative to ad exposure by granting interface enhancements or other benefits in exchange for a recurring or one-time fee.

At 930, the method involves the step of, upon activation of the subscription option, disabling the display of banner advertisements controlled by the advertisement integration module 422. Importantly, while banner ads are disabled, the method maintains the functionality of video advertisements for restoring lives (as described with respect to life management module 118 in FIG. 1) and skipping questions (as described in FIG. 7). The hybrid ad-subscription model ensures that essential game progression mechanisms tied to video ads remain intact, even for subscribed users, thereby supporting balanced monetization and uninterrupted gameplay functionality.

In accordance with some embodiments, the trivia game system 102 may be implemented using one or more computing devices or systems. The system may include at least one processor, memory, and a non-transitory computer-readable storage medium configured to store instructions executable by the processor to perform the operations of the system described herein.

The processor may be any suitable central processing unit (CPU), graphics processing unit (GPU), application-specific integrated circuit (ASIC), field-programmable gate array (FPGA), or a combination thereof, capable of executing software or firmware instructions. The memory may include volatile memory such as RAM, and the storage medium may include non-volatile memory such as flash memory, solid-state drives, hard disk drives, or cloud-based persistent storage.

The storage medium or a separate data infrastructure may further include a first database configured to store a plurality of visual stimuli, such as pictures, photos, graphics, icons, or other image-based assets. The visual stimuli may be indexed or categorized by topic, difficulty level, or semantic metadata to support contextual pairing with text prompts. A second database may be configured to store a plurality of textual prompts, wherein each textual prompt is associated with at least one visual stimulus from the first database. These associations may be many-to-many, thereby enabling the dynamic generation of varied trivia questions based on different visual-textual combinations.

The storage medium may store instructions that, when executed by the processor, cause the system to perform various operations using corresponding functional modules, including but not limited to: generating a plurality of trivia questions using a question generation module, each question comprising at least one visual stimulus and a textual prompt; detecting user input via a swipe-based interaction mechanism, where input indicates a response as to whether the visual-textual combination is true or false; awarding and managing virtual keys using a key management module; deducting and restoring game lives using a game life management module, including restoring lives in response to user interaction with advertisements; tracking user performance using a scoring module; adjusting the difficulty of presented questions using a difficulty adjustment module based on user performance data; delivering video or banner advertisements using an advertisement module; enabling question skipping in exchange for advertisement interaction via a question skip module or integrated functionality within the advertisement module; facilitating multiplayer interactions using a multiplayer module, which may handle matchmaking, real-time communication, and gameplay tracking; awarding ranking points and supporting in-game wagers using a wagering option and performance metrics; and controlling the presentation or suppression of banner advertisements using a subscription option configured to modify ad behavior for subscribed users.

In some embodiments, the system may be deployed across multiple devices, including but not limited to mobile phones, tablets, laptop or desktop computers, smart televisions, smart displays, gaming consoles, or head-mounted displays. Communication between modules or between client and server components may occur locally or over a network such as the Internet, a local area network (LAN), or a wireless communication protocol such as Wi-Fi or Bluetooth.

The present invention providing an interactive trivia game system has wide-ranging applications across various industries. In education, the system can be adapted for engaging learning experiences in subjects like history, science, and geography. The entertainment industry can leverage this system for creating captivating quiz shows and interactive content. Marketing firms can utilize the platform for brand engagement and product knowledge campaigns. In corporate training, the system can be employed for employee onboarding and skill assessment. The healthcare sector can adapt it for patient education and cognitive rehabilitation. Additionally, the tourism industry can implement this system for creating interactive city guides and cultural exploration games. The invention's versatility makes it a valuable tool for any sector seeking to combine information delivery with interactive engagement.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

1. A trivia game system comprising:
a question generation module configured to generate a plurality of trivia questions, each trivia question comprising at least one visual stimulus and a textual prompt, wherein each trivia question is configured to be presented on a display interface;
a swipe-based interaction mechanism configured to detect a user input with respect to the presented trivia question, wherein the user input indicates a response as to whether the combination of the visual stimulus and the textual prompt is true or false;
a key management module configured to:
award one or more virtual keys to a user for responding to questions, and
manage the use of virtual keys to open virtual treasure chests;
a game life management module configured to:
deduct game lives from a user's game for incorrect responses;
restore lives over time; and
restore lives in response to user's interaction with advertisements;
a scoring module configured to track user performance based on correct and incorrect responses; and
a difficulty adjustment module configured to modify the difficulty of presented questions based on user performance.

2. The trivia game system of claim 1, further comprising a first database storing a plurality of visual stimuli, including pictures or photos.

3. The trivia game system of claim 1, further comprising a second database storing a plurality of textual prompts, each textual prompt associated with at least one of the visual stimuli.

4. The trivia game system of claim 1, wherein the display interface is configured to present the visual stimulus and the associated textual prompt simultaneously.

5. The trivia game system of claim 1, wherein the swipe-based interaction mechanism is configured to:
register a swipe to the right as indicating a true statement, and
register a swipe to the left as indicating a false statement.

6. The trivia game system of claim 1, further comprising:
an advertisement module configured to present video advertisements; and
a question skip option that allows users to skip a question by watching a video advertisement, wherein:
the skipped question is marked as completed; and
the key management module awards keys for the skipped question.

7. The trivia game system of claim 1, wherein the key management module is configured to award virtual treasure chests only when all questions in a predefined series are answered correctly.

8. The trivia game system of claim 1, further comprising:
a multiplayer module configured to:
facilitate gameplay between multiple users;
track user performance in multiplayer games; and
award ranking points based on multiplayer game outcomes; and
a wagering option allowing users to set custom wagers using in-game currency for multiplayer games.

9. The trivia game system of claim 1, further comprising:
an advertisement integration module configured to display one or more banner advertisements within the display interface; and
a subscription option that, when activated, disables the display of banner advertisements while maintaining the functionality of video advertisements for restoring lives and skipping questions.

10. A computer-implemented method for operating a trivia game, the method comprising:
presenting, via a display interface, a plurality of trivia questions comprising a combination of a visual stimulus and an associated textual prompt;
detecting, via a swipe-based interaction mechanism, a user input with respect to the presented trivia question, wherein the user input indicates a response as to whether the combination of the visual stimulus and the textual prompt is true or false;
awarding one or more virtual keys to a user for responding to questions;
managing the use of virtual keys to open virtual treasure chests;
deducting lives from the user for incorrect responses;
restoring lives over time or in response to user interaction with advertisements;
tracking user performance based on correct and incorrect responses; and
modifying the difficulty of presented questions based on the tracked user performance.

11. The method of claim 10, wherein presenting the trivia question comprises simultaneously displaying the visual stimulus and the associated textual prompt on the display interface.

12. The method of claim 10, wherein detecting the user input comprises:
registering a swipe to the right as indicating a true statement, and
registering a swipe to the left as indicating a false statement.

13. The method of claim 10, further comprising:
presenting a video advertisement in response to a user request to skip a question;
marking the skipped question as completed; and
awarding keys for the skipped question.

14. The method of claim 10, wherein managing the use of keys comprises awarding virtual treasure chests only when all questions in a predefined series are answered correctly.

15. The method of claim 10, further comprising:
facilitating gameplay between multiple users in a multiplayer mode;
tracking user performance in multiplayer games;
awarding ranking points based on multiplayer game outcomes; and
enabling users to set custom wagers using in-game currency for multiplayer games.

16. The method of claim 10, further comprising:
displaying one or more banner advertisements within the game interface;
providing a subscription option; and
upon activation of the subscription option, disabling the display of banner advertisements while maintaining the functionality of video advertisements for restoring lives and skipping questions.

17. The method of claim 10, wherein the visual stimulus is selected from a first database of visual stimuli including pictures or photos, and the textual prompt is selected from a second database of textual prompts, each textual prompt being associated with at least one of the visual stimuli.

18. The method of claim 10, wherein modifying the difficulty of presented questions comprises selecting visual stimuli and textual prompts that create more challenging combinations based on the user's improved performance.
